(19) United States
(12) Patent Application Publication
(10) Pub. No.: US 2021/0392500 A1
(43) Pub. Date: Dec. 16, 2021

(54) NETWORK INTERFACE DEVICE

(71) Applicant: Apple Inc., Cupertino, CA (US)

(72) Inventors: David T. Pollington, San Francisco, CA (US); Michael Billard, Mountain View, CA (US); Emily K. Witt, San Jose, CA (US); Jason Blackwell, Cupertino, CA (US)

(21) Appl. No.: 17/340,408

(22) Filed: Jun. 7, 2021

Related U.S. Application Data
(60) Provisional application No. 63/038,066, filed on Jun. 11, 2020.

(51) Int. Cl. H04W 12/64; H04L 29/06; H04W 12/65

(52) U.S. Cl. CPC H04W 12/64; H04L 63/0218; H04L 63/1416; H04W 12/65; H04L 63/0853

(57) ABSTRACT

Embodiments include a network interface device including a first communication component operative to connect to a data transfer network and a second communication component operative to connect to a peripheral device. In some embodiments the network interface device includes a network controller operatively coupled to the first and second communication components, where the network controller is configured to receive data from the data transfer network and transmit data to the peripheral device. The network interface device can also include a monitoring component communicably coupled with the first and second communication components. The monitoring component can be configured to track a parameter associated with the received and transmitted data, determine a security threat associated with the data at least partially based on comparing the tracked parameter to a defined state, and, in response to determining the security threat, cause the network controller to restrict the data transmitted to the peripheral device.

### CROSS-REFERENCE TO RELATED APPLICATION

This application is a non-provisional patent application of and claims the benefit to U.S. Provisional Patent Application No. 63/038,066, filed Jun. 11, 2020, and titled “Network Interface Device,” the disclosure of which is hereby incorporated herein by reference in its entirety.

### FIELD

The described embodiments relate generally to a network interface device. More particularly, the present embodiments relate to a network interface device that monitors and controls data transferred between a data transfer network and a peripheral device, where the network interface device sits between the network and the peripheral device.

### BACKGROUND

Some companies may work with one or more suppliers or vendors to produce and/or assemble the company's products or provide other services, such as technical support, back office functions, sales, or the like. In some cases, the company may rely on suppliers for other purposes such as servicing their products, providing product support, and so on. The suppliers may use network attached computing devices to provide these services. Oftentimes these machines and/or computers are connected to one or more data transfer networks such as an intranet, the Internet, or other local or wide area networks that are outside the control of the company. In some instances, these machines and/or computers may use an outside network to connect to a secure network operated by the company to obtain information for carrying out various tasks.

Network security for such equipment is typically provided and controlled by each supplier, and therefore may not be directly controlled or monitored by the company. These networks may be inherently untrusted due to the company's lack of information about or control over the supplier's equipment connections with these networks. Further, suppliers may have computers and/or equipment using operating systems that are no longer supported, which increases the company's security risk. It might be desirable for a company to bring trust to these types of untrusted networks to decrease security risks introduced during supplier interactions.

### SUMMARY

Embodiments described herein are directed to a network interface device including a first communication component that is operative to connect to a data transfer network, a second communication component that is operative to connect to a peripheral device, and a network controller that is operatively coupled to the first communication component and the second communication component. The network controller may be configured to receive data from the data transfer network and transmit the data to the peripheral device. The network interface device can also include a monitoring component communicably coupled with the first communication component and the second communication component. The monitoring component can be configured to track a parameter associated with the received and transmitted data, determine a security threat associated with the received data at least partially based in comparing the tracked parameter to a defined state, and in response to determining the security threat, cause the network controller to restrict the data transmitted to the peripheral device.

In some embodiments the tracked parameter includes an amount of data that is received from the data transfer network or an amount of data that is transmitted from the peripheral device. The defined threshold can be based on a previously tracked amount of data that was transferred between the data transfer network and the peripheral device, and in response to the amount of data exceeding the previously tracked amount of data, the network controller is configured to activate a firewall between the data transfer network and the peripheral device. The monitoring component can also be configured to track a data transfer trend at least partially based on an amount of data that has been transferred between the data transfer network and the peripheral device during a defined period of time and the defined threshold can be at least partially based on the data transfer trend. The tracked parameter can include a current amount of data that is transferred between the data transfer network and peripheral device that is tracked for the defined period of time.

In some cases, the tracked parameter comprises a data transfer rate for the received and transmitted data, and the defined threshold is based on a historic data transfer rate for data transferred between the data transfer network and the peripheral device. The network controller can operate as a transparent device between the data transfer network and the peripheral device.

In some examples, restricting the data transmitted to the peripheral device comprises activating a firewall that operates on the network interface device. In some examples, the peripheral device can include multiple ports, the data transmitted to the peripheral device is transmitted through a first port of the multiple ports, and the firewall is applied to the first port of the multiple ports.

Another set of embodiments is directed to a method for operating a network interface device that is used to monitor and restrict traffic between a data transfer network and a peripheral device. The method can include receiving, at the network interface device, data transmitted from the peripheral device to the data transfer network, monitoring an operating parameter of the network interface device, and comparing a current state of the operating parameter to a defined state for the operating parameter. The method can also include determining a security threat associated with the data at least partially based on the current state of the operating parameter falling outside the defined state, and in response to determining the security threat, transmitting an alert to a remote server indicating the security threat.

In some cases, monitoring the operating parameter includes determining a connected state of the network interface device, comparing the current state of the operating parameter to the defined state for the operating parameter includes determining if the connected state indicates that the network interface device has been disconnected from the data transfer network or the peripheral device, and transmitting the alert includes transmitting a wireless radio signal to a nearby network device. In some cases, the method can also include establishing, by the network interface device, a wireless peer connection with a nearby network device, and transmitting a message to the nearby network device using the wireless peer connection, wherein the message indicates that the network interface device has been disconnected from either the data transfer network or the peripheral device. In some examples, the method can include outputting a movement signal corresponding to the network interface device moving and using the acceleration signal to estimate how far the network controller has moved.

In some embodiments, the defined state comprises a movement threshold, and comparing the current state of the operating parameter to the defined state for the operating parameter comprises determining if how far the network controller has moved exceeds the movement threshold. In some examples, the method can further include outputting, by an ambient light sensor, a light signal indicative of ambient light, and monitoring the operating parameter comprises determining a change in the ambient light. The defined state can include a light threshold, and comparing the current state of the operating parameter to the defined state for the operating parameter comprises determining if the change in the ambient light exceeds the light threshold. In some examples, the sensor is further configured to cause the network controller to restrict the data being transferred between the data transfer network and the peripheral device in response to the current state of the operating parameter satisfying the defined state.

Another set of embodiments is directed to a network sensor that includes a network controller configured to communicably couple a peripheral device to a data transfer network and a location sensor configured to monitor a location of the network sensor and output a signal corresponding to the location of the network sensor. The network sensor can also include a processing unit that is configured to receive the signal from the location sensor, use the signal to determine that the network sensor is outside a physical boundary, and, in response to determining that the network sensor is outside the physical boundary, instruct the network controller to restrict data transfer between the data transfer network and the peripheral device.

In some cases, the location sensor includes a global navigation satellite system (GNSS) tracking device, the physical boundary comprises a set of defined GNSS coordinates, and determining that the network sensor is outside the physical boundary comprises determining that the GNSS tracking device has crossed at least one coordinate of the set of defined GNSS coordinates.

In some cases, the location sensor includes an altimeter, the physical boundary comprises a defined altitude change, and determining that the network sensor is outside the physical boundary comprises determining that a change in an altitude of the altimeter exceeds the defined altitude change. In some examples, the processing unit is further configured to transmit an alert to a remote server in response to determining that the network sensor is outside the physical boundary.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates an example of a system that uses one or more network interface devices to increase the security of networked equipment;

FIG. 2 illustrates an example of a network interface device that is used to increase security of networked equipment;

FIGS. 3A and 3B illustrate an example of a network interface device that is used to track a location of networked equipment;

FIG. 4 illustrates an example method for operating a network interface device;

FIG. 5 illustrates an example method for operating a network interface device; and

FIG. 6 illustrates an example method for operating a network interface device.

It should be understood that the proportions and dimensions (either relative or absolute) of the various features and elements (and collections and groupings thereof) and the boundaries, separations, and positional relationships presented there between, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments disclosed herein are directed to a network interface device for increasing the security of data transmissions that occur when equipment owned and operated by a supplier is connected to an untrusted network. As used herein, the term “untrusted network” refers to any or all of: networks that are outside the control of a company; networks that a company cannot monitor; or networks that have security policies beyond a company's control. In some cases, the network interface device can be used to increase the security of equipment (whether a supplier's equipment or a company's equipment, both of which are examples of “peripheral devices” as that term is used herein) that is used to connect to an untrusted network. A unique network interface device may be connected to a peripheral device, such that the network interface device monitors network communications between an individual peripheral device and a data transfer network.

One or more network interface devices can each be connected to a different peripheral device in a local region to form a subnet group, where the network interface devices are managed by an authenticated controller. The network interface devices can be configured to monitor traffic patterns between the data transfer network and the peripheral device to evaluate and/or determine a security risk associated with its associated device. For example, the network interface device can evaluate data traffic patterns between the peripheral device and the data transfer network to identify changes in these patterns that indicate that the peripheral device presents a security threat. Continuing the example, if a peripheral device starts scanning the other devices in its subnet, the network interface device can be configured to recognize this pattern and characterize it as a security threat. Accordingly, network monitoring can be carried out on an equipment-based basis (and may be pushed to the edge of the network), which allows each network interface device to be configured and/or adapt to the network interactions that occur between a specific peripheral device and the data transfer network.

In many cases, equipment operated by a supplier is connected to one or more data transfer networks, such as an internal network (e.g., a supplier controlled network), local area network, wide area network, wireless network, the Internet, or the like. As used herein, a “data transfer network” may be any one of, or a combination of, these networks. These network connections may be used by the supplier and/or the company to control equipment, perform quality control activities, track progress, troubleshoot issues, service products, and provide customer service/support, among other activities. In some cases, the company may use its own private network to connect to a supplier's equipment via the supplier's data transfer network, or a supplier may connect to a private network of the company to access specific information. For example, the company's private network may have access to confidential information related to its products, such as design specifications, manufacturing specifications, quality control parameters, cost information, order statuses, supply logistics, and so on. The company may use the connection between its private network and the supplier's data transfer network to monitor activities, such as manufacturing progress, perform quality control activities, and track the progress of products as they are manufactured and shipped. However, in many cases, the company may not have direct control over the security of the supplier's network(s), intervening third party networks, or the supplier's equipment. Accordingly, by using its private network to interface with the supplier's equipment via the supplier's data transfer network, the company may increase the risk that its private network will be accessed by unauthorized parties or for unauthorized purposes. In cases where a company is not using its network(s) to connect to a supplier's equipment, the company may desire to monitor network connections between a supplier's equipment and a data transfer network, for example, to prevent security breaches such as unauthorized access to their data, monitor for security threats that may develop at specific peripheral devices, and/or decide whether a specific peripheral device can be trusted.

In some cases, it may not be desirable or possible for the company to increase the security of the supplier's network or address the security concerns on a network level basis. For example, the supplier may manufacture parts for multiple different companies and different sets of equipment may be used for manufacturing different companies' products at different times. Further, the supplier may have equipment that operates using unsupported or legacy software that cannot be updated or patched in an efficient manner. In other situations, a supplier may work remotely, and/or perform tasks for the company using their own peripheral devices that connect to one or more untrusted networks. Accordingly, these factors may make it difficult for a company to ensure a desired level of security when working with third party suppliers.

In a first example embodiment, a network interface device can be used to increase security of network transactions at an equipment level scale. For example, the network interface device can be used to connect to supplier's equipment (which may be referred to as a “peripheral device” herein) to a data transfer network. The network interface device may be transparent to the network such that it does not have its own internet protocol (IP) address, but instead receives data from the data transfer network and transmits that data to the peripheral device, acting as a pass-through or intermediary between the network and peripheral device. The network interface device can also include a monitoring component that tracks, monitors, reports, and/or logs data transferred between the data transfer network and the peripheral device to identify security risks or other irregularities. The monitoring component can be configured to identify both trusted and untrusted data traffic patterns between a peripheral device and a data transfer network. For example, the monitoring component may track an amount of data that is typically transferred between the data transfer network and the peripheral device in a given time to develop baseline data transfer parameters for that peripheral device. The monitoring component may use these baseline parameters as a comparison for monitoring data transfer between the peripheral device and the data transfer network, which in turn may be used to determine a security risk associated with that particular peripheral device. For example, if the amount of data transferred between the peripheral device and the data transfer network suddenly increases, the network interface device may determine that a security threat exists, and data transferred to or from the peripheral device is no longer secure. In response, the network interface device may take corrective action like alerting the company, the supplier, activating a firewall, and/or isolating the peripheral device from the data transfer network. Accordingly, the network interface device may be used by the company to increase the security of individual pieces or groups of equipment owned and/or operated by a third party supplier.

In some cases, the network interface device can be remotely or otherwise virtually controlled by the company. For example, the network interface device may contain software that operates on a secure partition, and/or is encrypted or otherwise protected such that only the company or those authorized by the company can modify functionality of the network interface device. For example, the company may remotely access the network interface device to change or otherwise update its operating parameters, receive logged data, send or receive alerts from the network interface device, activate or implement security measures such as activating a firewall, monitor if the device has been tampered with, or track other security parameters. In some cases, hardware root of trust security protocols can be implemented between the company and the network interface device, such that the company uses cryptographic functions to enable secure communication with the network interface device.

In some cases, the network interface device may be coupled and decoupled to a peripheral device such that it monitors data transferred between the peripheral device and the data transfer network. A third party supplier may install the network interface device on their peripheral device(s) while they are performing activities for the company and then remove the network interface device if those peripheral devices are no longer being used for performing activities for the company. In this regard, the network interface device may be dynamically switched to different peripheral devices throughout a supplier's facility as that supplier performs different activities for the company. For example, one or more network interface devices may initially be attached to a first set of equipment while a third party supplier uses that equipment to perform manufacturing activities for the company. Then, those network interface devices may be transferred to other equipment, for example, as the third party supplier uses different equipment to assemble the manufactured components. In some cases, the network interface devices may be activated while the third party supplier performs activities for the company and deactivated when that supplier is not using corresponding peripheral devices for performing activities for the company.

In some cases, the network interface device may include one or more sensors for monitoring its operating parameters, which may be used in coordination with the monitored data to provide an additional layer of security. An “operating parameter,” as used herein, is a condition or state of the network interface device, such as a connected state of the device, a location, movement, temperature, light level, or other physical parameter associated with the network interface device. The operating parameter may be determined using information about the operation of the device, such as status information provided by a processing unit, information obtained from one or more onboard sensors, or the like. Examples of operating parameters include a network device's location, acceleration, movement, position, light sensed by the device (whether external or within a housing of the device), a connected state with respect to a peripheral device, temperature, and so on. In some cases, this may be useful in determining if the network interface device has been tampered with, disconnected from the network, disconnected from the peripheral device or otherwise modified in an authorized or undesirable way. In some cases, the network interface device can include any or all of a battery such that it can operate when disconnected from a data transfer network or a peripheral device; an accelerometer and/or gyroscopic sensor for evaluating movement or other physical disturbances of the network interface device; an ambient light sensor; an altimeter; a radio for communicating via alternative modalities such as wireless peer-to-peer connections; a global navigation satellite system (GNSS) device from tracking locations of the network interface device; an antenna for receiving wireless signals, and so on.

In some embodiments, a security risk for network traffic of a particular device may be derived from a combination of the network data (e.g., traffic pattern analysis) and the operating parameter data (e.g., location, movement, and/or tampering analysis). For example, the combination of changes in network traffic and changes in location of the device may indicate a security threat indicating that the attached peripheral device can no longer be trusted.

In some embodiments, the network interface device may track its location and/or the location of a peripheral device to which the network interface device is connected. Tracking the peripheral device may allow the company to determine a location of a peripheral device, geofence equipment such that an alert is generated if the peripheral device moves outside a defined physical boundary, or alter or limit communications between a peripheral device and a data transfer network based on a position of the peripheral device.

Using network interface devices to monitor individual or groups of equipment that are owned or operated by one or more third party suppliers can increase a company's security with respect to that third party supplier, and vice versa. For example, monitoring individual peripheral devices may increase the accuracy of determining whether a specific peripheral device poses a security threat. In some cases, monitoring individual peripheral devices using the network interface device may allow the company to detect security risks that would not be detected by simply increasing the security of the network as a whole. In other cases, monitoring individual peripheral devices using the network interface device may allow individual peripheral devices to be isolated, quarantined or otherwise addressed, while allowing the other peripheral devices to continue to operate. These and other advantages of the network interface devices will be appreciated in light of the examples provided herein.

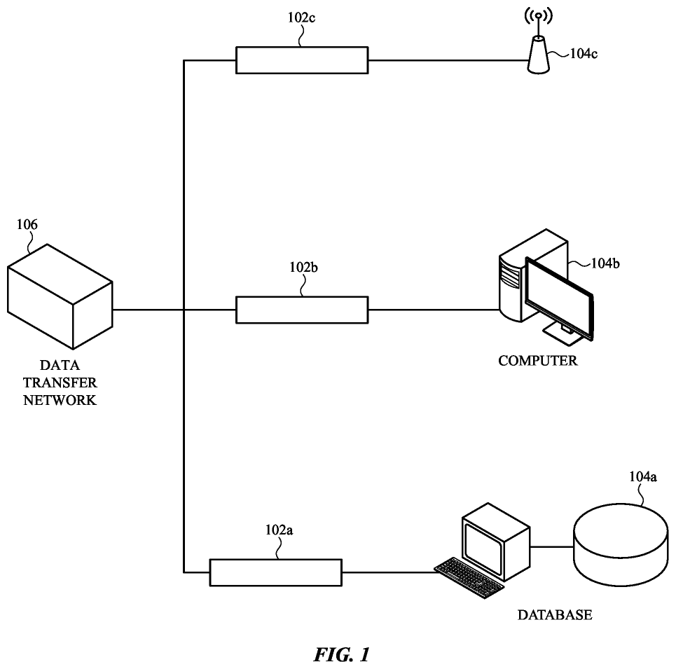

These and other embodiments are discussed below with reference to FIGS. 1-6. However, those skilled in the art will readily appreciate that the detailed description given herein with respect to these Figures is for explanatory purposes only and should not be construed as limiting.

FIG. 1 illustrates an example of a system 100 that uses one or more network interface devices 102 to increase the security of network connections between peripheral devices 104 and a data transfer network 106. The network interface device 102 can be connected between a peripheral device 104 and the data transfer network 106 such that it can monitor data that is transferred between the peripheral device 104 and the data transfer network 106. In some embodiments, the network interface device 102 is a transparent device that is not assigned an IP address. The network interface device 102 can receive data from the data transfer network 106, track one or more parameters associated with the data, and transmit the data to the peripheral device 104, thereby serving as a pass-through. The network interface device 102 can also receive data from the peripheral device 104, track one or more parameters associated with this data received from the peripheral device 104, and transmit the data to the data transfer network 106, likewise serving as a pass-through.

The parameters tracked by the network interface device 102 can be used to evaluate a security threat and/or trust level of the network connection between the peripheral device 104 and the data transfer network 106. In this regard, the tracked parameters may include information about data transfer traffic patterns between the peripheral device 104 and the data transfer network 106 such as: data volumes, data transfer rates, scheduling/timing of data transfers, port scanning, and so on; information about IP routing of data transferred to or from the peripheral device 104, such as a source or destination of transferred data; information about the data being transferred or the data packets themselves; historic trends associated with one or more of these parameters, and so on. In some cases, the network interface device 102 may be configured with or develop trusted traffic patterns that are used to evaluate whether a specific peripheral device 104 poses a security threat and/or associate a trust level with the peripheral device 104.

In some embodiments, the network interface device 102 can be configured to track or otherwise monitor a variety of different parameters relating to communication traffic patterns between the network interface device 102 and the data transfer network 106. Tracked parameters may include IP routing information, such as destination addresses for the data, types of data included in transferred packets, schedules/timing of data transfers, data requests received over the data transfer network, port scanning activities, or the like. The network interface device 102 can be configured to determine if a security threat exists based on a state or condition associated with one or more of these parameters. A “parameter,” as used herein, is a condition of data or a data stream, such as a destination to which data may be transmitted, an amount of data transmitted to a peripheral device or across a data transfer network, metadata regarding data packets or streams (e.g., size, type, envelope, formatting, and the like), data transmission speed, and so on. A “state” is a condition or threshold of a parameter.

For example, the network interface device 102 can be configured to determine that a security threat exists if based on a specific type of data, an IP address that is used to send data to the peripheral device 104, an IP address that the peripheral device 104 is transmitting data to, and so on. In alternative embodiments, the network interface device 102 may communicate with a remote electronic device that may receive information from the network interface device, determine whether a security threat exists, and instruct the network interface device to take actions if such a threat exists. That is, in alternative embodiments the network interface device 102 may track data and report that data, a summary of that data, or information related to that data to a remote electronic device that may perform the security threat analysis.

In some cases, a defined threshold is used to evaluate one of more of the tracked parameters. For example, when first installed, the network interface device 104 may be configured with a threshold for determining if the amount of data transferred over a defined period of time between the peripheral device 104 and the data transfer network 106 poses a security threat. The network interface device 102 may monitor the current amount of data transferred between the peripheral device 104 and the data transfer network 106 over the defined period of time, and compare the current amount of transferred data to the defined threshold. If the current amount of data is less than the threshold, the network interface device 102 may determine that there is no significant security risk. However, if the current amount of transferred data is greater than or equal to the defined threshold, the network interface device may determine that there is a security risk.

In some embodiments, the defined threshold or state of the tracked parameter may be determined by the network interface device 102 based on a data transfer history between the peripheral device 104 and the data transfer network 106. For example, the network interface device 102 may track over time one or more parameters associated with data transfers between the peripheral device 104 and the data transfer network 106. The network interface device 102 may use this tracked/historic data to determine a defined threshold or one or more states for the tracked parameters. Accordingly, the defined threshold or states may be customized or configured for each different peripheral device 104, which may increase the accuracy of the network device evaluating a security risk associated with a particular peripheral device.

The network interface device 102 or remote server can be configured to analyze the tracked parameters in a variety of ways. In some cases, this may include determining a parameter, such as an amount of data, a data transfer rate, a frequency, or the like. The parameter may be compared to one or more thresholds (or other states) to determine if a security threat exists. For example, if an amount of data transferred in a defined period of time surpasses a threshold, or a data transfer rate surpasses a threshold, the network interface device 102 may determine that there is a security threat associated with the peripheral device. In other cases, the network interface device 102 may analyze a current state of a tracked parameter to determine if a security threat exists. For example, the network interface device 102 may monitor destination IP addresses for data transferred from the peripheral device, and, if it detects unknown IP addresses, may determine that a security threat exists Similarly, the network interface device 102 may monitor parameters such as packet types, sizes, or other metadata regarding data packets in order to assess whether a security threat exists. In some embodiments, tracking one or more parameters may include performing data analysis such as averaging, statistical regressions, developing relationships between collected or logged data, and the like.

In some embodiments, the network interface device can use historic traffic patterns between the peripheral device 104 and the data transfer network to evaluate a security risk associated with a particular peripheral device 104. For example, traffic history can be used to develop machine learning models that can be used to differentiate between trusted data traffic patterns and untrusted data traffic patterns. In this regard, trusted and untrusted traffic patterns for each peripheral device 104 can be established and stored on the network interface device 102. In some examples, the network interface device can update, refine, and/or be configured with additional traffic patterns (trusted and untrusted) over time based on a specific peripheral device's 104 interaction with the data transfer network 106.

As one example, a first peripheral device 104a may be a terminal connected to a database 104a, which is connected to the data transfer network 106. In this example, the first peripheral device 104a can include a database that is accessed using the data transfer network 106. When performing activities for a company, the first peripheral device 104a may store information, including files (examples of which include company records, product information, product specifications, pricing information, and the like) that are used by the company. Under routine operation, when there is no security threat, the first peripheral device 104a may use this information via the data transfer network 106, which may include information related to products or services provided by the company. A first network interface device 102a may connect the first peripheral device 104a to the data transfer network 106 and may monitor the data transferred between the first peripheral device 104a and the data transfer network 106. The first network interface device 102a may track one or more parameters associated with the transmitted data such as an amount of data transferred over a defined period of time, data transfer rates, timing of data transfers, IP routing information, content of the transferred data, and so on to develop one or more data transfer patterns/trends associated with the first peripheral device 104a. The network interface device 102 may use these trends to develop a defined threshold for the one or more tracked parameters of data transmitted between the first peripheral device 104a and the data transfer network 106.

In the example of the first peripheral device 104a, the database may be limited to transferring certain types of files, and/or may only be accessed by authorized devices and/or users. In this regard, the first network interface device 102a may be used to monitor data and traffic patterns specific to the functions of the database. The first network interface device 102a may be pre-configured/programmed with these data transfer patterns/parameters, such as the type of data that is being transferred, timing of the data transfers, typical amounts of data being transferred, IP routing information (such as the data's destination), packet sizes or types, and so on. In some cases, the first network interface device 102a can track these parameters over time to develop and/or characterize the types of data being transferred, patterns in the data transfers, thresholds such as those associated with typical amounts of data being transferred, IP routing information, and so on (all of which are examples of parameters). Irregularities or deviation from the typical or defined states for one or more parameters can indicate that a security threat is present.

The first network interface device 102a may actively monitor or track in real time one or more of these parameters, such as an amount of data transferred from the first peripheral device 104a to the data transfer network 106 or the timing of the tracked data in relation to a defined schedule or status request received from the data transfer network 106, and compare this information to the one or more defined thresholds or states. If the tracked parameter satisfies one or more of the defined thresholds and/or states, the first network interface device 102a may determine that there is a security threat. For example, the first network interface device 102a may start detecting a larger volume of data being transferred from the first peripheral device 104a and also determine that these larger data transfers are occurring outside the defined schedule. Accordingly, the first network interface device 102a may determine that there is a security threat associated with the first peripheral device 104a.

In some cases, the first network interface device 102a can be used to identify or authenticate a device, or user, that is accessing the first peripheral device 104a. For example, the first interface device 102a can receive information about the identity of the first peripheral device 104a, such as a computer identification number for a terminal used to access the database, operating system information for the terminal and/or database, user login information, and so on. In some cases, a user may be required to provide biometric authentication information (examples of which include a fingerprint, retinal pattern, blood vessel pattern, facial information, voice pattern. and so on) to access the database. In this regard, the first network interface device 102a can receive this information from the first peripheral device 104a and use the information to evaluate a security risk associated with network communications between the first peripheral device 104a and the data transfer network 106. For example, the first network interface device 102a can be configured with a list of devices or users who are authorized to access the first peripheral device 104a. When a device or user attempts to access the first peripheral device 104a over the data transfer network 106, the first network interface device 102a may receive the identity and/or authentication credentials for this interaction, for example, from the first peripheral device 104a. The first network interface device 104a can compare these received credentials with its stored credentials for authorized devices and/or users. Based on this comparison, the first network interface device 104a may determine that the access is authorized and may correlate such access with a low security threat. Alternatively, if the first network interface device 104a determines that the access is not authorized, it can correlate such access with a high security threat.

A single data transfer network (data transfer network 106) is shown for clarity of illustration. However, the system 100 can operate using multiple connected or distinct data transfer networks. For example, the one or more peripheral devices 104 may be connected to a first network operated by a supplier, and the company may connect to the supplier's network via their own private network. In some cases, the company may own the network interface devices 102 and connect to the network interface devices 102 using their private network to interface with the supplier's network (data transfer network 106). The company may virtually activate, deactivate, configure, and communicate with their network interface devices 102 and/or receive alerts, messages, or other information from one or more of the network interface devices through the data transfer network.

In some embodiments, a second network interface device 102b may be used to connect a second peripheral device 104b to the data transfer network 106, which may be the same or a different data transfer as that described in relation to the first peripheral device 104a. The second peripheral device 104b may be a different piece or type of equipment than the first peripheral device, such as a computing device that is used to service a company's products, provide customer support by the company or a third party vendor, and access a private network owned or operated by the company. The second network interface device 102b may be used to evaluate a security risk of data transmissions between the second peripheral device 104b and the data transfer network 106. Accordingly, the second network interface device 102b may be adapted/configured to track one or more parameters based on the functions specific to the second peripheral device 104b.

For example, the second peripheral device 104b can be a computer used by a third party vendor to provide customer support for a company's products. The second peripheral device 104b may access the company's private network to obtain product support information for a defined set of products. Accordingly, the second network interface device 102b may track IP routing information to see what information the second peripheral device 104b is requesting. In some cases, the second peripheral device 104b could be configured to access the data transferred from the company's private network and to the second peripheral device 104b. For example, the company could configure the second peripheral device with encryption keys for the data the second peripheral device is authorized to access. Accordingly, if the second peripheral device 104b starts trying to access unauthorized locations or is receiving unauthorized data, the second peripheral device 104b may be able to detect this using the IP routing information and/or the encryption keys provided by the company. In some cases, if the second peripheral device 104b receives data from the company's private network and the second network interface device is not able to decrypt this data using its configured encryption keys, the second network interface device may determine that the second peripheral device 104b has become a security threat.

By way of another example, a third network interface device 102c may connect a third peripheral device 104c to the data transfer network 106. The third peripheral device 104c may include a wireless access point such as a WiFi access point, a Bluetooth access point, or a long term evolution (LTE) network, examples of which include a 4G or 5G access point that is used to communicate with one or more pieces of equipment via a wireless protocol. For example, the equipment could include automated manufacturing and assembly equipment that is used to produce the company's products. Accordingly, the third peripheral device 104c may be configured to evaluate and/or pass on data related to security threats in the network connection between the third peripheral device 104c and the data transfer network 106. For example, if the third peripheral device 104c is a wireless access point that serves a set of automated manufacturing equipment, data transfer rates over the network connection may be relatively constant due to the repetitive nature of the automated manufacturing activities. Accordingly, the third network interface device 102c may be configured with a threshold for the expected data transfer rates between the third peripheral device 104c and the data transfer network 106. In some embodiments, the third network interface device 102c can also monitor the data transfer rates and determine a threshold based on historic data transfer rates that it monitored over the network connection. Using the threshold, the third network interface device 102c may actively track the data transfer rate between the third peripheral device 104c and the data transfer network 106. If the tracked data transfer rates go above the defined threshold, the third network interface device 102c may determine that there is a security threat associated with the third peripheral device 104c.

In response to a tracked parameter satisfying a defined threshold or state, the network interface device 102 may take action to address the security threat. This may include the network interface device 102 restricting data transmitted between the peripheral device 104 and the data transfer network. In some embodiments, restricting the data transfer includes activating a firewall at the network interface device 102 to filter data packets that are being transferred between the network interface device and the data transfer network 106. In some cases, restricting the data transfer may include quarantining the peripheral device 104 or one or more ports associated with the peripheral device 104. In other cases, the network interface device 102 may begin logging data transfer activities between the peripheral device 104 and the data transfer network 106. In other embodiments, the network interface device 102 may send an alert or message to the company that owns the network interface device 102 indicating that a security threat has been detected.

The network interface device 102 can be configured to interface with one or more remote devices that analyze the tracked data parameters, or data summarizing or related to such parameters, and/or instruct the network interface device 102 on how to respond. For example, the network interface device 102 can be configured to track and log one or more parameters for data transferred between a peripheral device 104 and the data transfer network 106. The network interface device 102 may send these tracked parameters to one or more remote devices, such as a processing server that is used by the company to perform data analysis. The processing server(s) can analyze the data to determine if a security threat is present or evaluate a security risk, and, based on this analysis, instruct the network interface device to take an action if needed. For example, if the processing server determines that there is a security threat at the first peripheral device 104a, the analysis server may instruct the first network interface device 102a to restrict the network connection between the first peripheral device 104a and the data transfer network. This may take the form of any or all of instructing the first network interface device 102a to activate a firewall, quarantine one or more ports of the first peripheral device 104a, throttle data transmission rates, ceasing transmission of certain types or sizes of data packets, or take some other remedial action. In some cases, the processing server(s) can analyze, utilize, or combine data from multiple different network interface devices 102 to determine if a security threat is present at a single peripheral device or multiple peripheral devices such as a common group of manufacturing equipment.

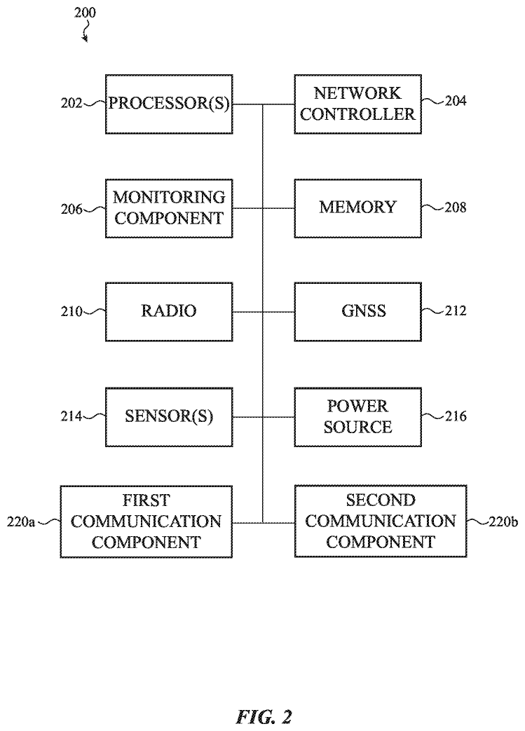

FIG. 2 illustrates an example of a network interface device 200 that is used to increase security of networked equipment. The network interface device 200 can be an example of the network interface devices described herein, such as network interface devices 102a-c. The network interface device 200 can include a processing unit 202, a network controller 204, a monitoring component 206, memory 208, a radio 210, a GNSS device 212, one or more sensors 214, and a power source 216. The network interface device can also include a first communication component 220a that is operative to connect to, receive data from, and/or pass data to a data transfer network and a second communication component 220b that is operative to connect to, receive data from, and/or pass data to a peripheral device, as described herein. The network interface device 200 can be used to implement one or more of the processes, methods, or techniques described herein to perform security monitoring and mitigation efforts to increase the security of network connections between a peripheral device and a data transfer network.

The processing unit 202 can control some or all of the operations of the network interface device 200. The processing unit 202 can communicate, either directly or indirectly, with some or all of the components of the network interface device 200. For example, a system bus (or another communication mechanism) can provide communication between the processing unit 202, the network controller 204, the monitoring component 206, the memory 208, the radio 210, the GNSS device 212, sensors 214, the power source 216, and the first and second communication components 220a, 220b.

The processing unit 202 can be configured to securely run one or more operating systems. For example, the processing unit 202 may be configured to access one or more secured memory partitions to prevent reprogramming, altering, or tampering with the operation of the network interface device 200 by unauthorized parties. In some cases, the processing unit 202 may be virtually accessed from a remote network and configured using one or more security credentials.

The processing unit 202 can be implemented as any electronic component capable of processing, receiving, or transmitting data or instructions. For example, the processing unit 202 can be a microprocessor, a central processing unit (CPU), an application-specific integrated circuit (ASIC), a digital signal processor (DSP), firmware, or combinations of such devices. As described herein, the term “processing unit” is meant to encompass a single processor or processing unit, multiple processors, multiple processing units, or any other suitable computing element or elements.

It should be noted that the components of the network interface device 200 can be controlled by multiple processing units. For example, select components of the network interface device 200 (such as network controller 204) may be controlled by a first processing unit and other components of the network interface device 200 (such as the monitoring component 206) can be controlled by a second processing unit, where the first and second processing units may or may not be in communication with each other.

The network controller 204 can be configured to connect the peripheral device to a data transfer network via one or more physical or data link standards such as Ethernet, WiFi, wireless mobile broadband, or the like. The network controller 204 can be configured to implement one or more security protocols such as quarantining a connected peripheral device (or one or more ports of the peripheral device) from a data transfer network, activating a firewall for filtering data packets transferred between the peripheral device and the data transfer network, sending alerts regarding security threats identified by the network interface device 200, and so on. In some cases, the network controller 204 can identify IP routing information from data packets transferred between a peripheral device and a data transfer network. The network controller 204 can be configured to be transparent to the data transfer network and the peripheral device and transmit data between the peripheral device and the data transfer network.

The monitoring component 206 may be operatively coupled at least with the network controller 204, the first communication component 220a, and/or the second communication component 220b. The monitoring component 206 may be implemented in software and/or firmware running on the processing unit 202, and configured to track a parameter that is associated with data that is transferred between the peripheral device and the data transfer network. In some cases, this may include real-time tracking, continuous tracking, and periodic tracking at defined or random intervals or a combination thereof. Tracking one or more parameters may include collecting and logging information regarding an amount of transferred data (total or over a defined period of time), data transfer rates, timing and duration information associated with transferred data, frequency, and so on. In some embodiments, tracking one or more parameters may include performing data analysis such as averaging, statistical regressions, developing relationships between collected or logged data, and the like.

In some embodiments, the monitoring component 206 can be configured to compare the tracked parameter(s) to one or more defined thresholds. The defined thresholds can be one or more preconfigured parameters, such as a parameter set by an owner of the network interface device 200. In some cases, the defined thresholds can be developed or refined by the monitoring component 206. For example, the monitoring component 206 can be configured with an initial defined threshold, such as one set by an owner of the device. As the monitoring component 206 tracks and collects information on data transferred between the peripheral device and the data transfer network, the monitoring component 206 can use trends associated with the data transfer history to refine or change the initial defined threshold. Additionally or alternatively, the monitoring component 206 can be implemented as a machine learning algorithm such as an adaptive neural network that is configured to recognize patterns in the transferred data.

In some cases, the monitoring component 206 can be configured with data transfer patterns that characterize trusted communication patterns and/or untrusted communication patterns. The configured patterns may be used by the monitoring component 206 to monitor and evaluate data transfers between a peripheral device and a data transfer network as described herein. Additionally or alternatively, the monitoring component 206 can log, track, or otherwise store data related to network traffic patterns between a specific peripheral device and a data transfer network. The monitoring component can send this tracked data to one or more remote servers, where it can be used to develop or refine machine learning models for analyzing data traffic patterns, for example, specific to the peripheral device that the network interface device is attached to. These machine learning models can be pushed to the network interface device and used by the monitoring component 206 to evaluate security risks associated with data transfers between the peripheral device and a data transfer network.

In some cases, the monitoring component 206 can be configured to track a variety of different parameters and/or data transfer patterns relating to data transferred between the network interface device and the data transfer network, such as IP routing information, destination addresses for the data, schedules/timing of data transfers, data requests received over the data transfer network, port scanning, or the like. The monitoring component 206 can be configured to determine if a security threat exists based on a state or condition associated with one or more of these parameters. For example, the monitoring component 206 could be configured to determine that a security threat exists based on a specific type of data, an IP address that is used to send data to the peripheral device, an IP address that the peripheral device is transmitting data to, and so on.

The memory 208 can store electronic data that can be used by the network interface device 200. For example, the memory 208 can store electrical data or content such as, for example, text, image, audio, or video files, documents and applications, device settings and user preferences, timing signals, control signals, and data structures or databases. The memory 208 can be configured as any type of memory. By way of example only, the memory 208 can be implemented as random access memory, read-only memory, flash memory, removable memory, other types of storage elements, or combinations of such devices. The memory 208 can store instructions that, when executed, cause the device to perform any or all of the functions described herein.

In some embodiments, the network interface device 200 can include one or more components that are used to track its location and/or determine if the network interface device has been tampered with, deactivated, disconnected or otherwise modified in an undesirable way. These components can include location trackers and one or more sensors as described herein. Further, the network interface device 200 can include components that allow it to send alerts and/or continue to function if it has been unplugged from the peripheral device or otherwise tampered with. For example, the network interface device 200 can include a battery and one or more wireless radios that may be used to communicate with other devices via side-channel connections.

One or more radios 210 can be configured to provide side channel communications between the network interface device 200 and other network interface device 200 or other nearby devices. In some cases, the radios 210 can be configured to communicate using different wireless communication protocols such as WiFi, Bluetooth, LTE (4G, 5G, or the like), or any other suitable wireless communication protocol. The radios 210 can be used to establish peer connections that are independent from the data transfer network. In some embodiments, the radios may be configured to initiate or communicate over side-channel or peer connections if the network interface device 200 is disconnected from the peripheral device and/or the data transfer network. In some cases, the radio(s) 210 can receive instructions or transmit data (in addition to and/or other than monitored data) to a remote device that may control operation of the interface device 200, perform processing functions discussed herein with respect to the interface device 200, or coordinate actions with the interface device 200. Generally, the sensor(s) 110 can include one or more antennas, such as omnidirectional antennas or directional antennas, or a combination thereof. One or more antennas may be configured to receive and/or transmit radio signals at specific frequencies or bandwidths such as a 2.5 gigahertz (GHz) antenna, 1.5 GHz antenna, and/or any other suitable antenna configuration.

The GNSS device 212 can be configured to determine a location of the network interface device 200. The GNSS device 212 can include a receiver that is capable of receiving information from one or more satellites to determine the network interface device's 200 geographic position, which may include latitude and longitude coordinates, altitude information, and the like. In some cases, other types of location sensors can be used alone or in combination with the GNSS device 212. For example, WiFi radios can be used to determine signal strength and triangulate locations of the network interface device 200. In other cases, magnetometers can be used to sense direction and motion. These types of location sensors, as well as other suitable position or directional sensors, can be used individually or in combination for location sensing, as discussed herein.

The network interface device 200 can also include one or more sensors 214. The sensor(s) 214 can be configured to sense one or more type of parameters, such as but not limited to, pressure, light, touch, heat, movement, relative motion, barometric data (such as changes in environmental pressure), and so on. For example, the sensor(s) 110 may include accelerometers, gyroscopic sensors, ambient light sensors, pressure sensors such as altimeters, and the like. Additionally, the one or more sensors 214 can utilize any suitable sensing technology, including, but not limited to, capacitive, ultrasonic, resistive, optical, ultrasound, piezoelectric, and thermal sensing technology.

The power source 216 can be implemented with any device capable of providing energy to the network interface device 200. For example, the power source 216 can be a power connector or power cord that connects one or more components of the network interface device, which could include the first and second communication components 220a, 220b. Additionally or alternatively, the power source 216 can be one or more batteries or rechargeable batteries, or a combination of batteries and power connectors. In this regard, the power source can be capable of providing uninterrupted power to the network interface device for a period of time, if the network interface device becomes disconnected from a continuous power supply.

The first and second communication components 220a, 220b can be formed in, contained in, or be positioned at least partially within and accessible through the housing of the network interface device 200. The first communication component 220a can connect the network interface device 200 to a data transfer network through a wired or wireless connection such as an Ethernet connection, or any other suitable interface. The second communication component 220b can connect the network interface device 200 to a peripheral device through a wired or wireless connection such as an Ethernet connection, or any other suitable interface. In some embodiments, the first and second communication components 220a, 220b may have a same type of connection interface. In other embodiments, the first and second communication components 220a, 220b can have different interfaces, such as the first communication component 220a connecting to the data transfer network via an Ethernet connection and the second communication component 220b connecting to the peripheral device through a different interface. Either or both of the first and second communication components 220a, 220b can be passthroughs, such as ports, or may include or execute functions designed to intelligently manage data transfer.

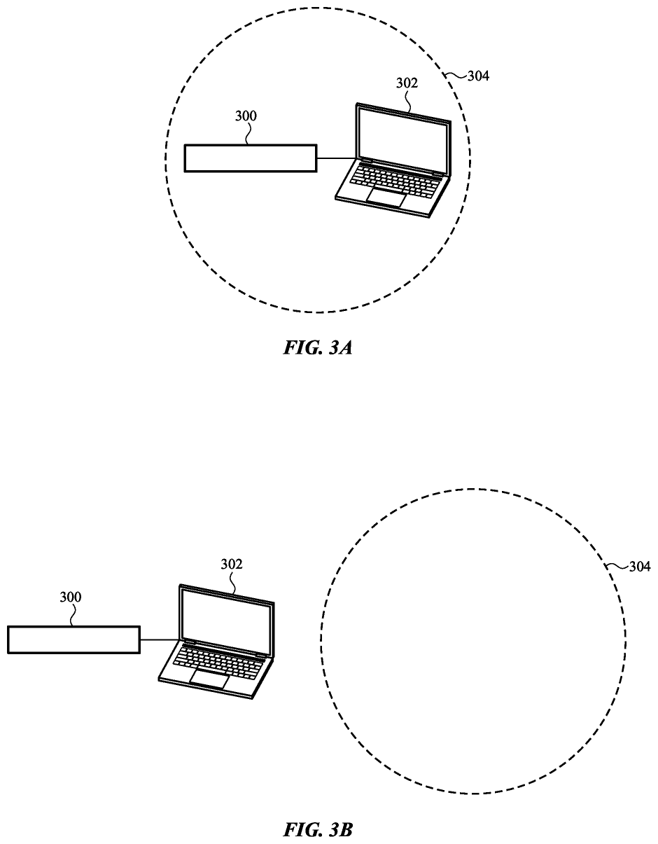

FIGS. 3A and 3B illustrate an example of a network interface device 300 that is operable to track a location of a peripheral device 302; this network interface device 300 may be, or incorporate, the functionality of the network interface devices 102a-c described above with respect to FIG. 1 or the network interface device 200 described with respect to FIG. 2. In some embodiments the network interface device 300 may be referred to as a network sensor, for example, when the network interface device is used to track a location of the peripheral device 302. As described herein, the network interface device 300 can include a location sensor such as a GNSS device, an altimeter, and/or track a location of the network interface device 300 using network information such as location data associated with WiFi connections, cellular connections (LTE), or the like. The network interface device 300 can use the information to determine its absolute (e.g., geographic location) and/or relative location (e.g., movement or distance from a given point, a change in altitude, or the like), which may be associated with, or correlated to, the peripheral device 302. That is, the network interface device's location may be used as a proxy for the peripheral device to which it is attached. Information from one or more different types of sensors may be combined or otherwise used to determine a location of the network interface device 300. For example, GNSS information may be combined with other position sensor information such as altimeter data, wireless positioning (e.g., WiFi, Bluetooth, LTE, and so on,), magnetometer data, or the like.

In some embodiments, the network interface device 300 can be configured with a boundary 304 such as a geofence or other location boundary, that is defined in relation to the absolute or relative position of the network interface device 300. In some cases, the boundary 304 may be associated with a physical boundary such as walls of a building, specific floor(s) within a building, a fence surrounding a property, and so on. The boundary 304 may be configured based on a type of the peripheral device 302, a location of the peripheral device 302, the intended use of the peripheral device 302, or other suitable parameter. For example, if the peripheral device 302 is a large piece of machinery located in a manufacturing facility, the boundary 304 may be defined to closely align with the footprint of that machine since that machine is intended to remain in the same location. If the peripheral device 302 is a laptop, the boundary 304 may be defined based on the intended area in which the laptop would be, or is, used, such as an office, suite, building, and so on. Thus, the boundary 304 may permit the laptop to move within a limited region. In other situations, the boundary 304 could be more expansive, such as if the peripheral device is a shipping vehicle; in such a case the boundary 304 could encompass a planned route for the shipping vehicle. In some case, the boundary 304 could be dynamically updated.

The network interface device 300 may be configured to track the peripheral device 302 relative to the boundary 304. As illustrated in FIG. 3A, data from one or more sensors may be used to determine that the network interface device 300 is located within the boundary 304. The network interface device 300 may continuously or periodically update its location information to track its position. In some cases, for example where the peripheral device 302 is not expected to move, the network interface device 300 may determine its location less frequently. In cases where the peripheral device 302 is expected to move more frequently, such as where the peripheral device is a laptop, the network interface device 300 may update its location more frequently. In some cases, the network interface device 300 may adjust a frequency of its location tracking based on how quickly the peripheral device 302 is moving.

As illustrated in FIG. 3B, the network interface device 300 may determine that the peripheral device 302 has moved outside the boundary 304 and restrict data transferred between the peripheral device 302 and a data transfer network and/or send an alert to an owner of the device (the company), as described herein. In some embodiments, the boundary 304 may be a set of GNSS coordinates that define an enclosed or open region, and the network interface device 300 can be configured to determine that the peripheral device 302 has moved outside the boundary if its coordinates cross a portion of the boundary 304. In other embodiments, the boundary 304 can be a defined altitude change, and the network interface device 300 can be configured to determine that the peripheral device 302 has moved outside the boundary 304 if it detects an altitude change greater than the defined altitude change. For example, in a multilevel manufacturing facility, it may be desirable to determine if the peripheral device 302 has moved to a different level. Accordingly, the defined altitude change may be based on height difference between different levels of the manufacturing facility.

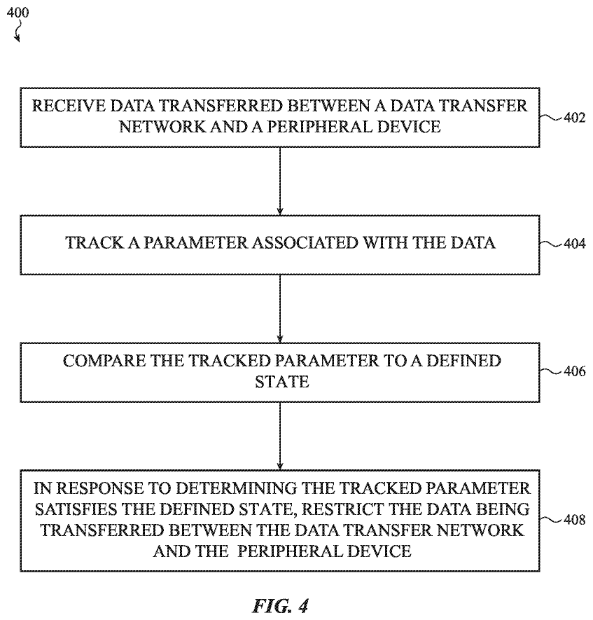

FIG. 4 illustrates an example method 400 for operating a network interface device. The method 400 may be performed using devices and systems as described herein such as the network interface devices, one or more data transfer networks, and one or more peripheral devices. The method 400 can be used to monitor and evaluate data signals transferred between the peripheral device and the data transfer network to determine a security risk associated with the network connection.

At 402, the network interface device may receive data from a data transfer network and transmit the data to a peripheral device. In some embodiments, the network interface device can transfer data in one direction (such as from the data transfer network and to the peripheral device or from the peripheral device and to the data transfer network) or in both directions (both to and from the peripheral device).

At 404, the network interface device may track a parameter associated with the data. For example, the network interface device may track data traffic patterns such as an amount of data transferred in a defined period of time, a data transfer rate, frequency or timing of the data transfers, or if the data transfers are in response to a request sent to the peripheral device. In some cases, the network interface device may use the tracked data to define and/or refine a threshold associated with the tracked parameter. For example, if a peripheral device has historically only transferred relatively small amounts of data at specific intervals, the network interface device may use this information to define the threshold. In other cases, if the peripheral device has a history of sporadic data transfers that vary widely in amount, the peripheral device may define a threshold with a high variability. In this case, the network interface device may track an additional or a different parameter with a lower variability.

At 406, the network interface device may compare the tracked parameter to a defined state, which may include trusted and/or untrusted traffic patterns, one or more defined thresholds, and so on. This may include determining whether a monitored traffic pattern (examples of which include an amount of data, timing, destination and/or source information, port scanning activities, and so on) matches with a defined state such as a trusted or untrusted traffic pattern. In some cases, this may include determining whether a value associated with the tracked parameter is greater than, equal to or less than a value associated with the defined threshold. In some cases, comparing the tracked parameter to the defined threshold may include statistical analysis such as a regression, determining a confidence interval, and so on. In some embodiments, the network interface device may use this analysis to determine what action to take.

At 408, the network interface device may determine that the tracked parameter satisfies the defined state. For example, the network interface device may determine that the tracked parameter corresponds to a known malicious data transfer pattern, and restrict the data being transferred between the data transfer network and the peripheral device, as described herein.

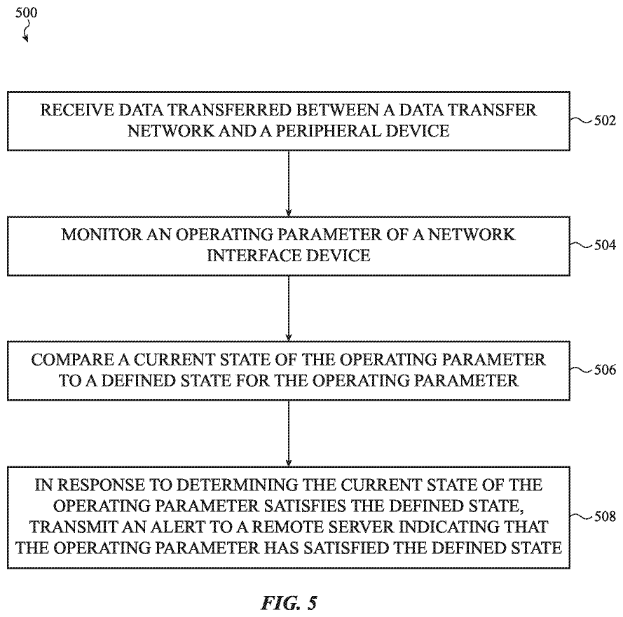

FIG. 5 illustrates an example method 500 for operating a network interface device. The method 500 may be performed using devices and systems as described herein, such as the network interface devices, one or more data transfer networks, and one or more peripheral devices. The method 500 may be used to monitor an operating state of the network interface to device to determine if the network interface device has been tampered with or modified in an unauthorized way.

At 502, the network interface device may receive data transferred between a data transfer network and a peripheral device, as described herein.

At 504, the network interface device can monitor one or more of its own operating parameters, which may be used to determine if it has been tampered with. For example, the network interface device may monitor its connected state to determine if it has been disconnected from either the peripheral device or the data transfer network. In some embodiments, the network interface device may include an accelerometer and/or a gyroscopic sensor as described herein, which may be used to determine if it has been moved, or otherwise been disturbed. The network interface device can also include an ambient light sensor as described herein, which may be used to determine an ambient light level associated with the peripheral device. In some cases, the ambient light sensor may be used to determine baseline light intensity/energy levels, changes in light levels, and/or patterns that can be correlated to different events such as day and night transitions. The network interface device may use this light information to determine one or more defined states. The defined states can be used to evaluate a security risk such as whether the network interface device has been tampered with. Other sensors may include temperature sensors, motion sensors, contact sensors, and so on.

At 506, the network interface device can compare a current state of one or more operating parameters to the defined state for a respective operating parameter. For example, the network interface device may monitor signals received from the accelerometer and compare these signals to one or more defined states for the acceleration parameter that indicate unauthorized movement of the network interface device. In some cases, the accelerometer can output an acceleration signal that indicates movement of the network interface device. In this regard, the acceleration signal can be used to estimate how far the network interface device has moved. In some cases, a movement threshold may be defined for the network interface device, which can be one or more limits for a magnitude of acceleration, amount of movement or disturbance, estimated distance of how far the network device has moved, or the like. Additionally or alternatively, the network interface device may monitor signals received from a gyroscopic sensor (e.g., an angular rate sensor, which is another example of a movement sensor) to determine whether it is being moved, tampered with or otherwise disturbed. In some cases, signals from one or more gyroscopic sensors may be compared to a defined state or threshold that indicates that the network device is being tampered with or experiencing other undesirable movement. For example, a defined threshold for the gyroscopic signals may be configured to differentiate between normal background movement or vibrations, such as those due to the routine operation of a piece of equipment, and more significant movement, such as the network interface device being physically picked up and/or manipulated.

If a light sensor is incorporated into the network interface device, ambient light data can be compared to a defined ambient light state that indicates unauthorized movement of the network interface device such as light parameters that deviate from expected system behavior. In some cases, the network interface device may compare a current state of multiple different operating parameters to each of their defined states and use the collective analysis to determine if it has been tampered with or changed in an unauthorized way.

At 508 the network interface device may determine that the current state of one or more operating parameters satisfies a defined state for that parameter and transmit an alert to a remote server. For example, the network interface device may send an alert to the company that owns/operates the network interface device. In some cases, the network interface device may attempt to send the alert as a secure message over the data transfer network. In other embodiments, the network interface device may use a side channel communication (e.g., a peer connection via a wireless communication system) to send the alert as described herein, such as if it has been disconnected from the data channel network.

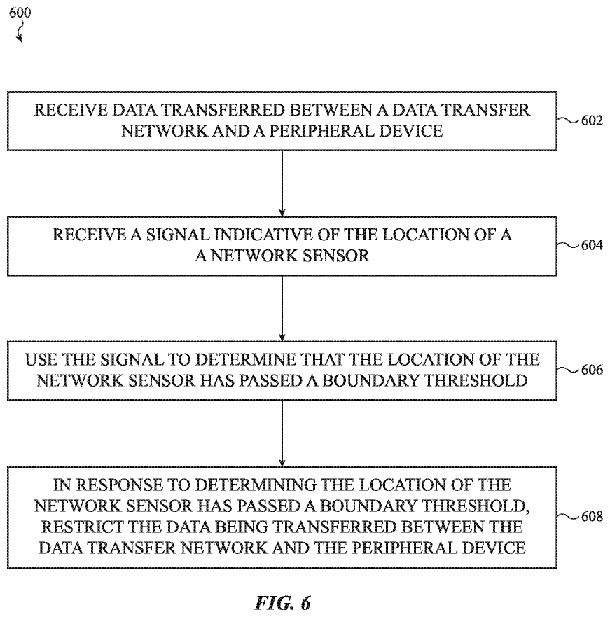

FIG. 6 illustrates an example method 600 for operating a network interface device. The method 600 may be performed using devices and systems and described herein such as the network interface devices, one or more data transfer networks, and one or more peripheral devices. The method 600 may be used to track a location of a network interface device and a peripheral device that it is connected to.

At 602, the network interface device may receive data transferred between a data transfer network and a peripheral device, as described herein.

At 604, the network interface device (processing unit thereof) may receive a signal from a location sensor (GNSS, altimeter, etc.) contained within a housing of the network interface device. The network interface device may use the location signal to determine an absolute or relative location of the peripheral device.

At 606, the network interface device may compare the location of the peripheral device to a physical boundary threshold. In some cases, the physical boundary threshold may be a geographical region such as a set of GNSS coordinates and the network interface device may compare its current geographical location to these GNSS coordinates. If its current geographical location crosses a portion of the boundary defined by the GNSS coordinates, the network interface device may determine that the peripheral device has crossed the boundary threshold. In some embodiments, the network interface device may use a relative measurement such as a change in altitude to determine if the peripheral device has crossed a boundary threshold. For example, the network interface device may determine that the peripheral device has crossed a boundary threshold if a detected change in altitude surpasses a defined altitude change.

At 608, the network interface device may determine that the location of the network interface device has passed a boundary threshold and restrict data being transferred between the peripheral device and the data transfer network as described herein.

As described above, certain aspects of the present technology permit monitoring data being transmitted through a network, determining a location and/or activity of equipment within a specified environment, and the like. The present disclosure contemplates that, in some instances, this gathered data may include personal information data that uniquely identifies or can be used to contact or locate a specific person. Such personal information data can include demographic data, location-based data, telephone numbers, email addresses, Twitter IDs (or other social media aliases or handles), home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to increase the security of network connections between a user device and a data transfer network. Further, other uses for personal information data that benefit the user are also contemplated by the present disclosure. For instance, monitoring a user's network connection may provide security that allows a user to access a company's private network to carry out any necessary tasks in working with the company.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (“HIPAA”); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of determining a user's presence, absence, or activities, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, monitoring network connections may be provided based on non-personal information data or a bare minimum amount of personal information, such as events or states at the device associated with a user, other non-personal information, or publicly available information.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C Similarly, it may be appreciated that an order of elements presented for a conjunctive or disjunctive list provided herein should not be construed as limiting the disclosure to only that order provided.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A network interface device, comprising:
a first communication component operative to connect to a data transfer network;
a second communication component operative to connect to a peripheral device;
a network controller operatively coupled to the first communication component and the second communication component, and configured to:
receive data from the data transfer network; and
transmit data to the peripheral device;
a monitoring component communicably coupled with the first communication component and the second communication component, the monitoring component configured to track a parameter associated with the received and transmitted data; and
a processing unit operative to:
determine whether a security threat exists by comparing the tracked parameter to a defined state; and
in response to determining the security threat exists, cause the network controller to restrict the data transmitted to the peripheral device.

2. The network interface device of claim 1, wherein:
the tracked parameter comprises one of an amount of data that is received from the data transfer network or an amount of data that is transmitted from the peripheral device;
the defined state is based on a previously tracked amount of data that was transferred between the data transfer network and the peripheral device; and
in response to at least one of the amount of data that is received from the data transfer network or the amount of data that is transmitted from the peripheral device exceeding the previously tracked amount of data, the network controller is configured to activate a firewall between the data transfer network and the peripheral device.

3. The network interface device of claim 1, wherein:
the monitoring component is configured to track a data transfer trend that is at least partially based on an amount of data that has been transferred between the data transfer network and the peripheral device during a defined period of time; and
the defined state is at least partially based on the data transfer trend.

4. The network interface device of claim 3, wherein the tracked parameter comprises the amount of data transferred between the data transfer network and the peripheral device during the defined period of time.

5. The network interface device of claim 1, wherein:
the tracked parameter comprises a data transfer rate for the transmitted data; and
the defined state is based on a historic data transfer rate for data transferred between the data transfer network and the peripheral device.

6. The network interface device of claim 1, wherein the network controller operates as a transparent device between the data transfer network and the peripheral device.

7. The network interface device of claim 1, wherein restricting the data transmitted to the peripheral device comprises activating a firewall that operates on the network interface device.

8. The network interface device of claim 7, wherein:
the peripheral device comprises multiple ports:
the data transmitted to the peripheral device is transmitted through a first port of the multiple ports; and
the firewall is applied to the first port of the multiple ports.

9. A method for operating a network interface device that is used to monitor and restrict traffic between a data transfer network and a peripheral device, the method comprising:
receiving, at the network interface device, data transmitted from the peripheral device to the data transfer network;
monitoring an operating parameter of the network interface device;
comparing a current state of the operating parameter to a defined state for the operating parameter;
determining a security threat exists at least partially based on the current state of the operating parameter not matching the defined state; and
in response to determining the security threat exists, transmitting an alert to a remote server indicating the security threat.

10. The method of claim 9, wherein:
monitoring the operating parameter comprises determining a connected state of the network interface device;
comparing the current state of the operating parameter to the defined state for the operating parameter comprises determining that the connected state indicates that the network interface device has been disconnected from the data transfer network or the peripheral device; and
transmitting the alert comprises transmitting a wireless radio signal to a nearby network device.

11. The method of claim 9, further comprising:
establishing, by the network interface device, a wireless peer connection with a nearby network device; and
transmitting a message to the nearby network device using the wireless peer connection, wherein the message indicates that the network interface device has been disconnected from either the data transfer network or the peripheral device.

12. The method of claim 9, further comprising:
outputting a signal corresponding to the network interface device moving; and
using the signal to estimate how far the network interface device has moved.

13. The method of claim 12, wherein:
the defined state comprises a movement threshold; and
comparing the current state of the operating parameter to the defined state for the operating parameter comprises determining if how far the network interface device has moved exceeds the movement threshold.

14. The method of claim 9, further comprising:
outputting, by an ambient light sensor, a light signal indicative of ambient light; and wherein
monitoring the operating parameter comprises determining a change in the ambient light.

15. The method of claim 14, wherein:
the defined state comprises a light threshold; and
comparing the current state of the operating parameter to the defined state for the operating parameter comprises determining if the change in the ambient light exceeds the light threshold.

16. The method of claim 9, wherein, in response to the current state of the operating parameter satisfying the defined state, the network interface device is further configured to restrict the data being transferred between the data transfer network and the peripheral device.

17. A network sensor, comprising:
a network controller configured to communicably couple a peripheral device to a data transfer network;
a location sensor configured to monitor a location of the network sensor and output a signal corresponding to the location of the network sensor; and
a processing unit configured to:
receive the signal from the location sensor;
use the signal to determine that the network sensor is outside a boundary; and
in response to determining that the network sensor is outside the boundary, instruct the network controller to restrict data transfer between the data transfer network and the peripheral device.

18. The network sensor of claim 17, wherein:
the location sensor comprises a global navigation satellite system (GNSS) tracking device;
the boundary comprises a set of defined GNSS coordinates; and
determining that the network sensor is outside the boundary comprises determining that the GNSS tracking device has crossed at least one coordinate of the set of defined GNSS coordinates.

19. The network sensor of claim 17, wherein:
the location sensor comprises an altimeter;
the boundary comprises a defined altitude change; and
determining that the network sensor is outside the boundary comprises determining that a change in an altitude of the altimeter exceeds the defined altitude change.

20. The network sensor of claim 17, wherein, in response to determining that the network sensor is outside the boundary, the processing unit is further configured to transmit an alert to a remote server.
